(19) United States
(12) Patent Application Publication
(10) Pub. No.: US 2023/0196394 A1
(43) Pub. Date: Jun. 22, 2023

(54) RENTAL CAR MANAGEMENT SYSTEM CAPABLE OF DETERMINING PRICE USING BIG DATA

(71) Applicant: KAFLIX Co., Ltd., Jeju-si (KR)

(72) Inventor: Hyeong-Joon YOON, Jeju-si (KR)

(21) Appl. No.: 17/677,944

(22) Filed: Feb. 22, 2022

(30) Foreign Application Priority Data
Dec. 16, 2021 (KR) 10-2021-0180914

(51) Int. Cl. G06Q 30/02; G06Q 30/06

(52) U.S. Cl. CPC G06Q 30/0206; G06Q 30/0627; G06Q 30/0645

(57) ABSTRACT

Provided is a rental car management system. More particularly, provided is a rental car management system capable of determining a price using big data, wherein the system stores a variable affecting a rental car use ratio and information on the use ratio to form big data, derives a correlation therebetween to estimate the rental car use ratio at a specific time point, and computes the price according to the estimated use ratio, whereby prices of rental cars are reasonably determined.

### CROSS REFERENCE TO RELATED APPLICATION

The present application claims priority based on Korean Patent Application No. 10-2021-0180914, filed on Dec. 16, 2021, the entire contents of which is incorporated herein for all purposes by this reference.

### BACKGROUND OF THE INVENTION

### Field of the Invention

The present disclosure relates to a rental car management system. More particularly, the present disclosure relates to a rental car management system capable of determining a price using big data, wherein the system stores therein a variable affecting a rental car use ratio and information on the use ratio to form big data, derives a correlation therebetween to estimate the rental car use ratio at a specific time point, and computes the price according to the estimated use ratio, whereby prices of rental cars are reasonably determined.

### Description of the Related Art

Rental cars, which are rented and used for a predetermined time period and returned, are generally used in tourist sites for the convenience of sightseeing. In particular, it is essential to use rental cars on islands, for example, Jeju Island, or tourist sites where public transportation is inconvenient.

However, arranged prices of rental cars vary from company to company, so it is difficult for tourists or consumers to recognize fair prices of rental cars. In a high season, excessively high fees are set, and also in low season, it is common that a low discount is received and overcharging occurs.

Therefore, the patent document below was filed disclosing a system for determining a price of a rental car, but only information on a basic reference price was provided and reasonable price determination has not achieved yet.

In addition, consumer trust in rental car companies has been remarkably lowered because the consumers are requested to pay additional fees on-site or rental cars are not properly maintained. Accordingly, only the rental cars of large rental car companies have been actively used and the operation of small rental car companies has been more difficult.

The foregoing is intended merely to aid in the understanding of the background of the present disclosure, and is not intended to mean that the present disclosure falls within the purview of the related art that is already known to those skilled in the art.

### DOCUMENT OF RELATED ART

(Patent Document 1) Korean Patent Application Publication No. 10-2015-0137979 (published, 9 Dec. 2015) “SYSTEM FOR PROVIDING RENTAL CAR PRICE”

### SUMMARY OF THE INVENTION

Accordingly, the present disclosure has been made keeping in mind the above problems occurring in the related art.

The present disclosure is directed to providing a rental car management system, wherein big data is formed by storing variables affecting a rental car use ratio and information on the use ratio, a correlation therebetween is derived to estimate the rental car use ratio at a specific time point, and a price is computed according to the estimated use ratio, whereby prices of rental cars are reasonably determined.

The present disclosure is directed to providing a rental car management system, wherein a correlation with a rental car use ratio is analyzed using, as variables, information on a rental car model, a time, such as a day and a month, a season, such as a high season, and weather when the car is used in addition to an influx ratio of tourists entering an area where rental cars are used, so that price calculation is achieved accordingly, thereby facilitating an accurate estimation of a use ratio and price computation.

The present disclosure is directed to providing a rental car management system, wherein a price based on an estimated use ratio is adjusted according to a time period remaining until a use time point for a rental car, and the degree to which the price is adjusted is adjusted according to a time, a season, and a reservation ratio at the use time point, thereby reasonably determining a price according to a reservation time point.

The present disclosure is directed to providing a rental car management system, wherein a price for each rental car company is set and provided, and a preference degree for each company for a rental car is analyzed and is applied in price setting, so that small rental car companies able to improve the management level of the rental cars and an appropriate price is rewarded accordingly, contributing to the improvement of the operational performance of the small rental car companies.

The present disclosure is directed to providing a rental car management system, wherein when a rental car reservation is canceled, a cancellation fee discount benefit is given to the user and the user is persuaded to approve a resale of the rental car reservation, and when the resale is approved, the sale of the rental car reservation is made at a discounted price to reduce a cancellation ratio of rental car reservations, whereby user and operator losses are reduced and the reliability of the rental car management system is increased.

In order to achieve the objectives above, the present disclosure is realized by an embodiment having the following configurations.

According to an embodiment of the present disclosure, there is provided a rental car management system including: rental cars that a user may to rent and use for a predetermined time period and return; a user terminal configured to search the rental cars to select the rental car to be used, and receive information on the rental cars; and a management server configured to communicate with the user terminal so that a contract for use of the rental car is made, and manage the information on the rental cars, wherein the management server is configured to analyze a correlation between a use ratio for the rental cars and variables affecting the use ratio for the rental cars so as to calculate an estimated use ratio according to the correlation, and set and provide prices according to the estimated use ratio.

According to another embodiment of the present disclosure, in the rental car management system, the management server may include: a price model determination part configured to analyze the correlation between the use ratio for the rental cars and the variables affecting the use ratio for the rental cars; and a price calculation part configured to calculate the prices of the rental cars at a predetermined time point according to the correlation analyzed by the price model determination part, and provide the prices.

According to still another embodiment of the present disclosure, in the rental car management system, the price model determination part may include: a variable information storage module configured to store therein information on the variables affecting the use ratio; a use ratio information storage module configured to store therein the use ratio of the number of the used rental cars to the total number of the rental cars; a correlation derivation module configured to derive the correlation between the information on the variables and information on the use ratio; and a correlation update module configured to update the correlation every predetermined time, wherein the variable information storage module may include: a car model information storage module configured to store therein information on models of the cars; a time information storage module configured to store therein information on a day and a month when the cars are used; a season information storage module configured to store therein information on a season when the cars are used; a weather information storage module configured to store therein information on weather conditions; and an influx ratio storage module configured to store therein information on an influx ratio of persons entering an area where the rental cars are used, wherein the influx ratio storage module may be configured to store therein the influx ratio of the persons actually entering the area to persons allowed to be transported by transportation means, such as airplanes and ships, which enter the area where the rental cars are used.

According to still another embodiment of the present disclosure, in the rental car management system, the price calculation part may include: a selection information reception module configured to receive information on the selection of the rental car by the user; a variable information loading module configured to load the variables for estimating the use ratio for the rental cars according to the information on the selection by the user; an estimation use ratio calculation module configured to estimate the use ratio for the rental cars by applying the loaded variables to the correlation derived by the price model determination part; a price reference setting module configured to set a price reference according to the use ratio; and a price computation module configured to compute the prices according to the estimated use ratio and the set price reference, and to provide the prices to the user, wherein the variable information loading module may be configured to load the information on the car models, the time when the cars are used, the season, the weather conditions, and a reservation ratio for the transportation means so as to apply the same to the correlation.

According to still another embodiment of the present disclosure, in the rental car management system, the management server may include a price adjustment part configured to adjust the prices calculated by the price calculation part, according to a time period remaining until a time period of use of the rental car selected by the user, and to provide the adjusted prices, wherein the price adjustment part may include: a time period index setting module configured to set a price adjustment degree according to the remaining time period; a weighting setting module configured to set a weighting for the price adjustment degree; an adjustment index computation module configured to apply the weighting to a time period index so as to compute a final adjustment index for adjusting the prices; and a price change module configured to change the prices calculated by the price calculation part, according to the computed adjustment index, wherein the weighting setting module may include: a time-specific setting module configured to set the weighting according to a day and a month of the time period of use of the rental car; a season-specific setting module configured to set the weighting according to a season; and a reservation ratio-specific setting module configured to set the weighting according to a reservation ratio for the rental cars.

According to still another embodiment of the present disclosure, in the rental car management system, the management server may include a company-specific provision part configured to display the prices from rental car companies in a classified manner, wherein the company-specific provision part may include: a company-specific price display module configured to display, to the user terminal, the prices from each of the companies calculated by the price calculation part; a grade information loading module configured to load grade information of the rental cars of each of the companies; a review analysis module configured to analyze review information of the rental cars of each of the companies; a preference index computation module configured to compute a preference degree for each of the companies according to the grade information and the review information; a preference reference setting module configured to set a price adjustment degree according to the preference degree; and a price application module configured to apply, to the prices calculated by the price calculation part, the price adjustment degree based on a reference set by the preference reference setting module.

According to still another embodiment of the present disclosure, in the rental car management system, the management server may include a cancellation resale part configured to enable a resale of a rental car reservation canceled by the user, wherein the cancellation resale part may include: a cancellation request reception module configured to receive cancellation request information from the user; a sale possibility determination module configured to determine whether the resale of the rental car reservation requested to be canceled is possible; a sale recommendation module configured to recommend, before cancellation, the user for the resale on condition that a cancellation fee is discounted when it is determined the resale is possible; and a sale posting module configured to enable the resale of the rental car reservation at a discounted price when the user approves the resale, wherein the sale possibility determination module may include: an estimation use ratio reception module configured to receive information on the use ratio estimated by the price calculation part for a rental car reservation time period; a reservation ratio reception module configured to receive information on a current reservation ratio; a reservation progress ratio computation module configured to compute a reservation progress ratio of the current reservation ratio to the estimated use ratio; a time period application module configured to apply a time period remaining until the reservation time period to the reservation progress ratio so as to revise the reservation progress ratio; and a possibility determination module configured to determine whether the resale is possible, by comparing the revised reservation progress ratio with a reference value.

According to the above-described embodiments and the following features, combinations, and relations of use that will be described later, the present disclosure has the following effects.

According to the present disclosure, big data is formed by storing variables affecting a rental car use ratio and information on the use ratio, a correlation therebetween is derived to estimate the rental car use ratio at a specific time point, and a price is computed according to the estimated use ratio, whereby prices of rental cars are reasonably determined.

According to the present disclosure, a correlation with a rental car use ratio is analyzed using, as variables, information on a rental car model, a time, such as a day and a month, a season, such as a high season, and weather when the car is used in addition to an influx ratio of tourists entering an area where rental cars are used, so that price calculation is achieved accordingly, thereby facilitating an accurate estimation of a use ratio and price computation.

According to the present disclosure, a price based on an estimated use ratio is adjusted according to a time period remaining until a use time point for a rental car, and the degree to which the price is adjusted is adjusted according to a time, a season, and a reservation ratio at the use time point, thereby reasonably determining a price according to a reservation time point.

According to the present disclosure, a price for each rental car company is set and provided, and a preference degree for each company for a rental car is analyzed and is applied in price setting, so that small rental car companies able to improve the management level of the rental cars and an appropriate price is rewarded accordingly, contributing to the improvement of the operational performance of the small rental car companies.

According to the present disclosure, when a rental car reservation is canceled, a cancellation fee discount benefit is given to the user and the user is persuaded to approve a resale of the rental car reservation, and when the resale is approved, the sale of the rental car reservation is made at a discounted price to reduce a cancellation ratio of rental car reservations, whereby user and operator losses are reduced and the reliability of the rental car management system is increased.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a configuration diagram illustrating a rental car management system capable of determining a price using big data according to an embodiment of the present disclosure;

FIG. 2 is a block diagram illustrating a configuration of a management server of FIG. 1;

FIG. 3 is a block diagram illustrating a configuration of a price model determination part of FIG. 2;

FIG. 4 is a block diagram illustrating a configuration of a price calculation part of FIG. 2;

FIG. 5 is a block diagram illustrating a configuration of a price adjustment part of FIG. 2;

FIG. 6 is a block diagram illustrating a configuration of a company-specific provision part of FIG. 2;

FIG. 7 is a block diagram illustrating a configuration of a cancellation resale part of FIG. 2;

FIG. 8 is a block diagram illustrating a configuration of a management server according to another embodiment of the present disclosure;

FIG. 9 is a block diagram illustrating a configuration of a car information collection part of FIG. 8;

FIG. 10 is a block diagram illustrating a configuration of a traffic information provision part of FIG. 8;

FIG. 11 is a block diagram illustrating a configuration of a traffic information optimization part of FIG. 8;

FIG. 12 is a block diagram illustrating a configuration of an impact monitoring part;

FIG. 13 is a block diagram illustrating a configuration of a danger recognition module of FIG. 12;

FIG. 14 is a block diagram illustrating a configuration of an abnormality check module of FIG. 12;

FIG. 15 is a block diagram illustrating a configuration of a fuel cost computation part of FIG. 8;

FIG. 16 is a block diagram illustrating a configuration of a fuel cost discount part of FIG. 8;

FIG. 17 is a block diagram illustrating a configuration of a fine computation part of FIG. 8;

FIG. 18 is a block diagram illustrating a configuration of a tourist route provision part of FIG. 8;

FIG. 19 is a block diagram illustrating a configuration of a store information provision part of FIG. 8; and

FIG. 20 is a block diagram illustrating a configuration of a network diagnosis part of FIG. 8;

### DETAILED DESCRIPTION OF THE INVENTION

Hereinafter, a rental car management system capable of determining a price using big data according to exemplary embodiments of the present disclosure will be described in detail with reference to the accompanying drawings. In describing the present disclosure, it is to be noted that if a detailed description of the known function or configuration makes the subject matter of the present disclosure unclear, the detailed description will be omitted. Throughout the specification, when a part “includes” an element, it is noted that it further includes other elements, but does not exclude other elements, unless specifically stated otherwise. In addition, the terms “-part”, “-module”, and the like mean a unit for processing at least one function or operation and may be implemented by hardware or software or a combination thereof.

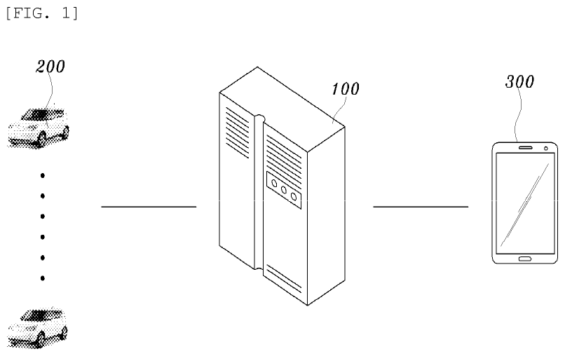

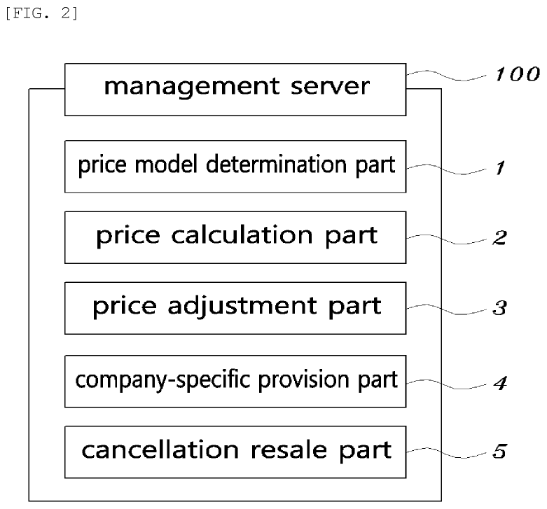

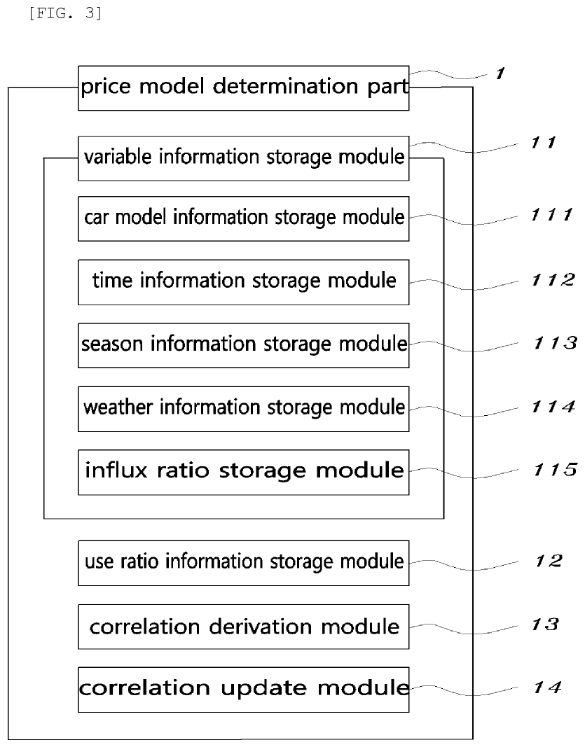

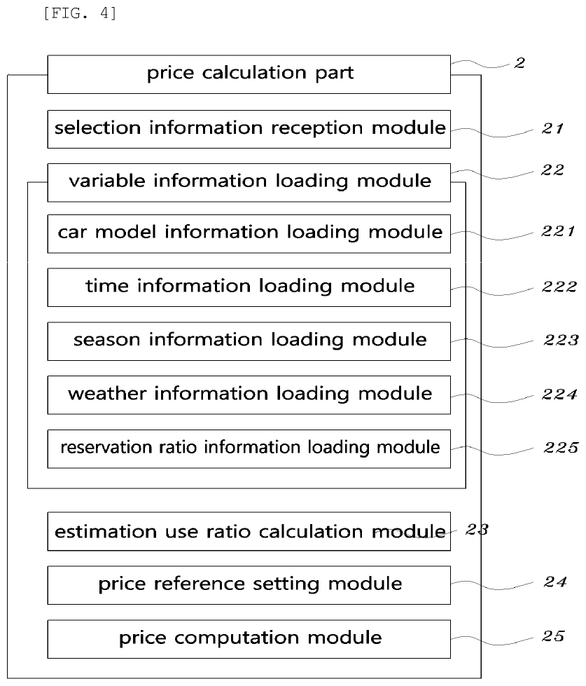

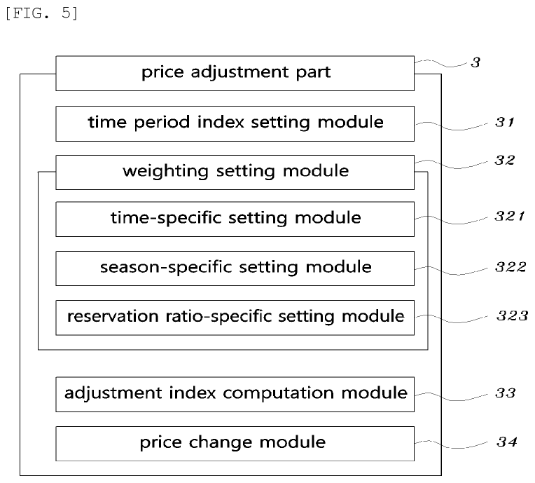

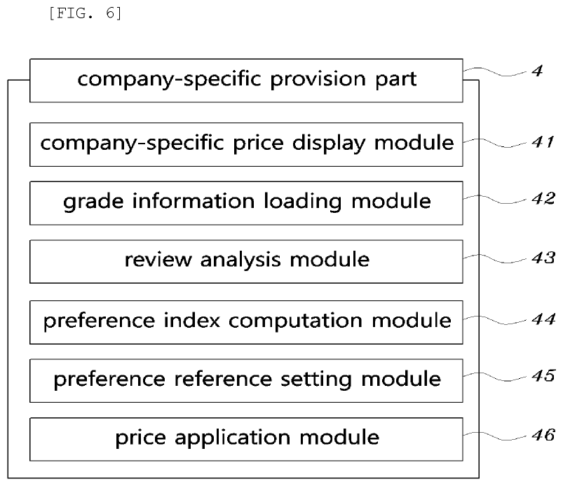

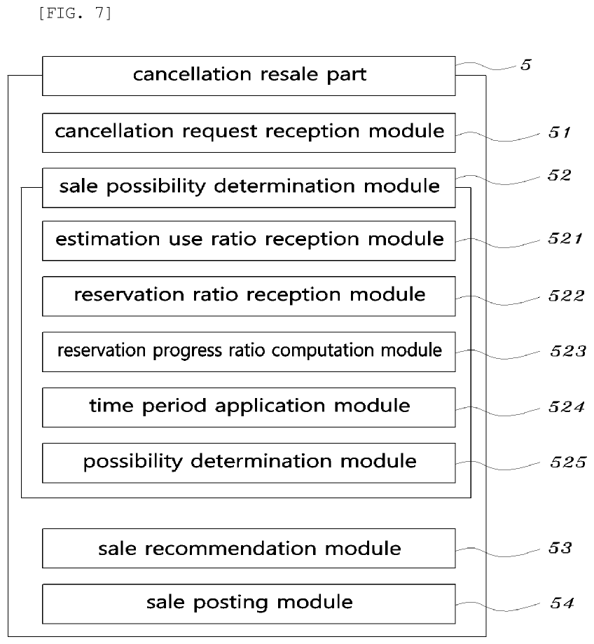

A rental car management system capable of determining a price using big data according to an embodiment of the present disclosure will be described with reference to FIGS. 1 to 7. The rental car management system includes: rental cars 200 that a user may to rent and use for a predetermined time period and return; a user terminal 300 configured to search the rental cars 200 to select the rental car 200 to be used, and receive information on the rental cars; and a management server 100 configured to communicate with the user terminal 300 so that a contract for use of the rental car 200 is made, and manage the information on the rental cars 200.

According to the present disclosure, the rental car management system enables contracts for use of rental cars 200 to be made through the management server 100, and a rental car user uses the user terminal 300 connected to the management server 100 through wired/wireless communication so as to search for and select a required rental car, whereby a contract for use is made. In particular, according to the present disclosure, rental fees for the rental cars 200 are calculated according to a rental car use ratio estimated on the basis of the big data, thereby determining a price fair and reasonable for both a rental car company and a user. Therefore, as the user terminal 300, various devices capable of wired/wireless communication with the management server 100 may be applied, such as a smartphone, a tablet PC, and a PC. The user terminal 300 receives information on the rental cars 200 from the management server 100 and displays the information. The user terminal 300 selects the rental car 200 to be used so that a contract for use is made. The user terminal 300 receives various types of information on the rental cars 200.

The management server 100 is configured to communicate with the user terminal 300 in a wired/wireless manner, to make contracts for use of the rental cars 200, and manage and provide various types of information on the rental cars 200. In particular, the management server 100 determines rental fees for the rental cars 200 and provides the rental fees for rental car companies in a classified manner. When a reservation of the rental car 200 is canceled, a resale of the rental car 200 is made, thereby obtaining the reliability of the management system and reducing the user's loss due to cancellation. In particular, the management server 100 enables reasonable prices to be provided through big data-based determination of the prices of the rental cars 200, and enables the prices to be adjusted for each reservation period for the rental cars 200, thereby increasing a reservation ratio and achieving efficient operation. To this end, the management server 100 may include a price model determination part 1, a price calculation part 2, a price adjustment part 3, a company-specific provision part 4, and a cancellation resale part 5.

The price model determination part 1 is configured to derive a correlation for determining a rental price (hereinafter, referred to as a “price”) of a rental car. The price model determination part 1 derives a correlation for estimating the rental car use ratio through analysis of the big data. Therefore, the price model determination part 1 collects, for a predetermined time period, information on the rental car use ratio and variables affecting the rental car use ratio, and derives a correlation therebetween, so that using the derived correlation, the price calculation part 2 determines rental car prices for a specific unit time period. For example, the price model determination part 1 may collect information on the variables and the use ratio on a daily basis to derive the correlation. According to the information collected everyday, the correlation may be updated to increase the accuracy of the correlation. To this end, the price model determination part 1 may include a variable information storage module 11, a use ratio information storage module 12, a correlation derivation module 13, and a correlation update module 14.

The variable information storage module 11 is configured to collect and store therein information on the variables affecting the rental car use ratio. The variable information storage module 11 may include: a car model information storage module 111 storing therein information on car models; a time information storage module 112 storing therein information on a time, such as, days and months; a season information storage module 113 storing therein information on seasons, such as, a high season, a low season, a semi-high season, and holidays; a weather information storage module 114 storing therein weather information, such as a temperature, precipitation, a wind speed, and humidity; and an influx ratio storage module 115 storing therein information on an influx ratio of tourists who enter the area where the rental cars 200 are used. Herein, the influx ratio stored by the influx ratio storage module 115 is set as the ratio of the number of persons who actually enter the area to the total number of persons allowed to be transported by transportation means, such as ships and airplane, which enter the area. The information is collected and stored.

The use ratio information storage module 12 is configured to collect and store therein information on the use ratio for the rental cars 200. The ratio of the number of actually used rental cars 200 to the total number of available rental cars 200 is set as a use ratio, and the use ratio is collected and stored. For example, the use ratio may be calculated and stored on a daily basis.

The correlation derivation module 13 is configured to derive a correlation between the variables stored by the variable information storage module 11 and the use ratio for the rental cars 200 stored by the use ratio information storage module 12. The derivation of the correlation is performed using the big data collected for a predetermined time period with respect to the variables and the use ratio. The correlation derivation module 13 enables an analysis of the correlation to be conducted by various machine learning methods, such as an artificial neural network. The correlation may be analyzed on a per-day basis with respect to the variables and the use ratio. In addition, the correlation derivation module 13 enables the correlation to be described for each car model. Input variable values are set according to a day, a month, and a season, and weather information, such as precipitation, a temperature, humidity, and a wind speed, and the influx ratio are input input variables, so that the correlation with the rental car use ratio is derived.

The correlation update module 14 is configured to update the correlation derived by the correlation derivation module 13. The correlation update module 14 revises the correlation continuously by using the variables and the use ratio data collected after the correlation is derived. Therefore, the correlation update module 14 enables the accuracy of the correlation to increase over time.

The price calculation part 2 is configured to calculate and determine rental prices for the rental cars 200. Using the correlation derived by the price model determination part 1, the use ratio for the rental cars 200 at a specific time point is estimated, and prices are computed according to the estimated use ratio. In other words, the higher the estimated rental car use ratio a specific time point, the greater the demand for use of the rental cars. Therefore, the price calculation part 2 may be set high prices when a high rental car use ratio is estimated. In addition, the price calculation part 2 calculates and determines prices on a daily basis. According to a rental time period selected by the user, prices may be calculated and provided on a daily basis. To this end, the price calculation part 2 may include a selection information reception module 21, a variable information loading module 22, an estimation use ratio calculation module 23, a price reference setting module 24, and a price computation module 25.

The selection information reception module 21 is configured to receive information selected through the user terminal 300. The information on the model of the rental car 200 and a rental time period that the user wants is received.

The variable information loading module 22 is configured to load input variables for estimating the rental car use ratio and computing prices. The variables for the car model and the rental time period selected by the user are loaded. Accordingly, the variable information loading module 22 enables the use ratio for the rental cars 200 to be estimated for the car model and the rental time period selected by the user, and enables prices to be determined according to the estimated use ratio. To this end, in the variable information loading module 22, the following are performed. A car model information loading module 221 loads information on the car model selected by the user. A time information loading module 222 loads time information, such as a day and a month, for the time period during which the user wants to use the rental car 200. A season information loading module 223 loads information on seasons such as a high season. A weather information loading module 224 loads weather forecast information such as precipitation and a temperature. A reservation ratio information loading module 225 loads reservation ratio information of a transportation mean, such as a ship and an airplane, which arrives in the area where the rental car 200 is used. Herein, the weather information loading module 224 may load the weather forecast information from an external weather forecast system. The reservation ratio information loading module 225 loads the reservation ratio information for a time period during which the rental car 200 is desired to be used, through a server of an operator that manages reservations of ships and airplanes.

The estimation use ratio calculation module 23 is configured to estimate the use ratio for the rental cars 200 with respect to the time period during which the user wants to use the rental car 200. The use ratio is estimated using the correlation derived by the price model determination part 1. Accordingly, the estimation use ratio calculation module 23 inputs the variables loaded by the variable information loading module 22 to the correlation from the price model determination part 1 to calculate the estimated use ratio for the rental cars 200 for the time period of use of the rental car 200.

The price reference setting module 24 is configured to set a reference for determining prices according to the use ratio for the rental cars 200. The use ratio for the rental cars 200 may be divided into a plurality of sections, and prices may be set for each section, use ratio-based prices may be set for each car model.

The price computation module 25 is configured to compute and provide prices of the rental cars 200 that the user wants. The prices for the car model and the time period that the use wants are provided. The price computation module 25 determines prices according to the reference set by the price reference setting module 24 according to the estimated use ratio calculated by the estimation use ratio calculation module 23. Prices for each date in the time period during which the user wants to use the rental car may be computed and caused to be displayed.

The price adjustment part 3 is configured to adjust prices according to the time for which the user makes a reservation of a rental car. The prices computed by the price calculation part 2 are adjusted. The price adjustment part 3 may lower the price more as the rental car is reserved more early. In addition, the degree to which a price is adjusted may be controlled according to a time, a season, and a reservation ratio at the time when the user wants to use the rental car. Accordingly, the price adjustment part 3 adjusts prices according to the demand degree at the time point at which the rental car is used, so that determination of prices according to the reservation time point more reasonably and accurately performed. To this end, the price adjustment part 3 may include a time period index setting module 31, a weighting setting module 32, an adjustment index computation module 33, and a price change module 34.

The time period index setting module 31 is configured to set the degree to which a price is adjusted according to the time period remaining until the rental car use time period. The degree may be set such that the longer the remaining time period, the lower the price is adjusted.

The weighting setting module 32 is configured to set a weighting for the time period index set by the time period index setting module 31. The degree to which a price is adjusted may be controlled according to the time, the season, and the reservation ratio when the rental car 200 is used. Accordingly, the weighting setting module 32 may include a time-specific setting module 321, a season-specific setting module 322, and a reservation ratio-specific setting module 323. The time-specific setting module 321 may set the degree to which a price is adjusted, according to a month and a day of the time point at which the rental car is used. The season-specific setting module 322 may set the degree to which a price is adjusted, according to a season type, such as a high season, of the time point at which the rental car is used. The reservation ratio-specific setting module 323 may set the degree to which a price is adjusted, according to the reservation ratio for the rental car. Herein, the time-specific setting module 321 may reduce the degree to which a price is adjusted on a day, for example, Friday, Saturday, and Sunday. The season-specific setting module 322 may reduce the degree to which a price is adjusted in a season, for example, a high season. The reservation ratio-specific setting module 323 may reduce the degree to which a price is adjusted as the reservation ratio is higher. In addition, the reservation ratio-specific setting module 323 may set a weighting of the degree to which a price is adjusted with reference to the ratio of the reservation ratio at a current time point to the rental car use ratio estimated for the time point at which the rental car is used.

The adjustment index computation module 33 is configured to set the degree to which a rental car price is finally adjusted. The final adjustment index may be set by setting the weighting set by the weighting setting module 32 to the time period index set by the time period index setting module 31.

The price change module 34 is configured to change the prices calculated by the price calculation part 2 and display the prices to the user terminal 300. The change is performed by applying the final adjustment index computed by the adjustment index computation module 33, to prices.

The company-specific provision part 4 is configured to classify information on the rental cars 200, for example, prices, for each rental car company and provide the same. The calculation of the prices of the rental cars 200 may be performed for each company and provided. In this system according to the present disclosure, a plurality of rental car companies may be registered and used. Rental cars 200 that each company owns may be registered, and a contract for use of each of the rental cars 200 may be made to use the rental cars 200. Accordingly, the company-specific provision part 4 enables information on the rental cars 200 of each rental car company to be displayed separately and provided. In addition, the company-specific provision part 4 enables a correlation for a rental car use ratio of each rental car company to be analyzed separately and enables corresponding prices to be computed separately and provided. In addition, the company-specific provision part 4 analyzes grades and reviews for the rental cars for each company, applies a preference degree for each company to prices to provide the prices. Accordingly, the company-specific provision part 4 allows a high price to be computed for the company that has a high use ratio under the same condition for the companies. The rental car prices of the companies that are popular among users are raised, thereby achieving reasonable price determination. In addition, the higher price is determined as the company has the higher preference degree from users, which motivate companies to manage rental car quality better, and through this, the profitability of the companies may be improved. To this end, the company-specific provision part 4 may include a company-specific price display module 41, a grade information loading module 42, a review analysis module 43, a preference index computation module 44, a preference reference setting module 45, and a price application module 46.

The company-specific price display module 41 is configured to enable use prices to be displayed to the user terminal 300, for rental car companies in a classified manner. For each company, a correlation for the rental car use ratio is derived through the price model determination part 1, and a price is calculated through the price calculation part 2 and the price adjustment part 3 and is displayed for each company.

The grade information loading module 42 is configured to load grade information for each rental car company. Loaded is the grade information on the rental car input through the user terminal 300 after the rental car 200 is used. In this system according to the present disclosure, a grade for the rental car 200 used by the user may be registered through the user terminal 300. Information on this may be stored for each company and loaded through the grade information loading module 42.

The review analysis module 43 is configured to analyze a review of use of the rental car for each rental car company. Positive and negative preference degrees for rental car companies may be analyzed. The review analysis module 43 analyzes a review, such as a grade, written through the user terminal 300 and stored in the management server 100. In addition, review information for rental car companies may be collected from external various media and preference degrees may be analyzed.

The preference index computation module 44 is configured to compute a preference index that indicates the preference degree for a rental car company. The preference index may be computed through grade information loaded by the grade information loading module 42 and preference degree information from a review analyzed by the review analysis module 43. For example, the preference index computation module 44 may compute the preference index by adding an average value of grades and a score according to a preference degree of a review.

The preference reference setting module 45 is configured to set the degree to which a price is adjusted according to a preference index. The preference index computed by the preference index computation module 44 is divided into sections and the degree to which a price is adjusted may be determined according to each section. Herein, the preference reference setting module 45 may set a reference such that the higher the preference degree for a rental car company, the higher the price is set.

The price application module 46 is configured to apply a preference index to a price. According to the reference set by the preference reference setting module 45, a price is revised according to a preference index.

The cancellation resale part 5 is configured to make a resale of a canceled rental car reservation when the user cancels the rental car reservation. The rental car reservation is not immediately canceled, and a resale at a discounted price is made. If rental car reservations are frequently canceled through this system according to the present disclosure, the system may lose the trust of the rental car companies and the users have a loss by having to pay cancellation fees. Therefore, when a cancellation request is made through the user terminal 300, the cancellation resale part 5 determines whether cancellation is possible, first. When cancellation is possible, the cancellation resale part 5 requests the user for a resale on condition that a cancellation fee is discounted. When the user approves the resale, the resale of the rental car reservation is made at a discounted price. Through this, the cancellation resale part 5 minimizes cancellation of rental car reservations and maintains the trust from the point of view of the manager of the system. In addition, the cancellation resale part 5 reduces the loss caused by the cancellation for the user who has cancelled the reservation by discounting the cancellation fee. Discount sales of the rental car reservations may increase the sales rate of the cancelled reservations. To this end, the cancellation resale part 5 may include a cancellation request reception module 51, a sale possibility determination module 52, a sale recommendation module 53, and a sale posting module 54.

The cancellation request reception module 51 is configured to receive, from the user, cancellation information for a rental car reservation. Cancellation request information transmitted from the user terminal 300 is received.

The sale possibility determination module 52 is configured to determine whether cancellation is possible, for the rental car reservation requested to be cancelled. The possibility of a resale of the rental car reservation is determined. The sale possibility determination module 52 determines the possibility of a sale considering the rental car reservation ratio at the rental car use time point and the remaining time period. The possibility of a resale is determined considering whether the estimated use ratio is satisfied considering the time period remaining until the rental car use time point. To this end, the sale possibility determination module 52 may include an estimation use ratio reception module 521, a reservation ratio reception module 522, a reservation progress ratio computation module 523, a time period application module 524, and a possibility determination module 525.

The estimation use ratio reception module 521 is configured to receive estimated use ratio information at the use time point of the rental car requested to be cancelled. The estimated use ratio information calculated by the estimation use ratio calculation module 23 is received.

The reservation ratio reception module 522 is configured to receive current reservation ratio information at the use time point of the rental car requested to be cancelled. Received is information on the ratio of the number of currently reserved rental cars to the total number of owned rental cars.

The reservation progress ratio computation module 523 is configured to compute a reservation progress ratio at the use time point of the rental car requested to be cancelled. The reservation progress ratio is computed by dividing the reservation ratio received by the reservation ratio reception module 522 by the estimated use ratio received by the estimation use ratio reception module 521. Therefore, the reservation progress ratio computation module 523 may determine how many reservations are currently in progress compared to the estimation use ratio.

The time period application module 524 is configured to apply the time period remaining until the rental car use time point, to the computation of the reservation progress ratio. The reservation progress ratio computed by the reservation progress ratio computation module 523 is revised in a predetermined ratio, considering the remaining time period from the cancellation request time point to the rental car use time point.

The possibility determination module 525 is configured to determine the possibility of a resale of the rental car requested to be cancelled. The possibilty of a resale is determined using the reservation progress ratio information in which the remaining time period is considered by the time period application module 524. The possibility determination module 525 may set a predetermined reference value for determining that a resale is possible. When the reservation progress ratio revised by the time period application module 524 exceeds the reference value, the possibility determination module 525 determines that a resale is possible. For example, when an estimated reservation progress ratio based on the date of use of the rental car exceeds 90%, it is determined that a resale is possible.

The sale recommendation module 53 is configured to recommend the resale for the user who cancels the rental car reservation when it is determined by the sale possibility determination module 52 that the resale of the rental car reservation is possible. Information that the resale will reduce the cancellation fee is also provided.

The sale posting module 54 is configured to enable the resale of the rental car reservation to be made when the user who wants to cancel agrees on the resale of the rental car reservation. The rental car at a discounted price is posted to make a sale.

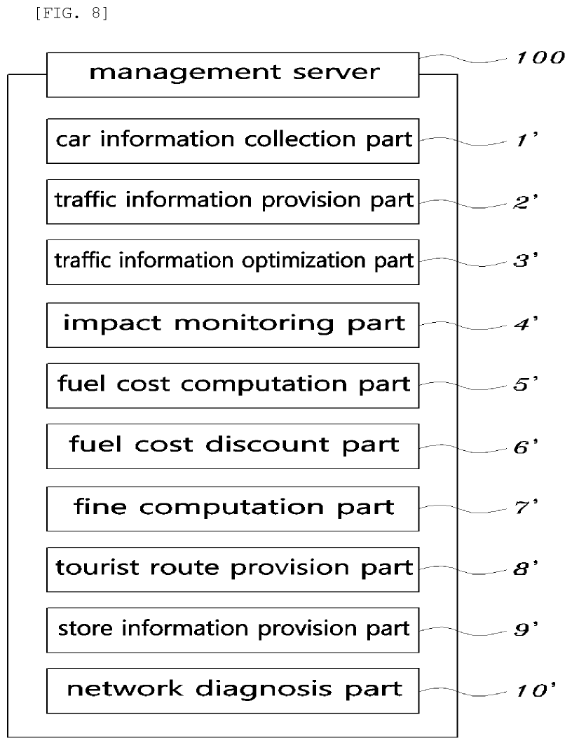

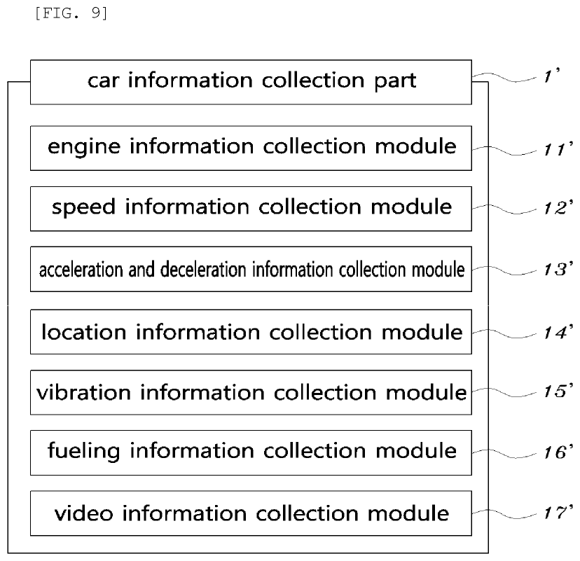

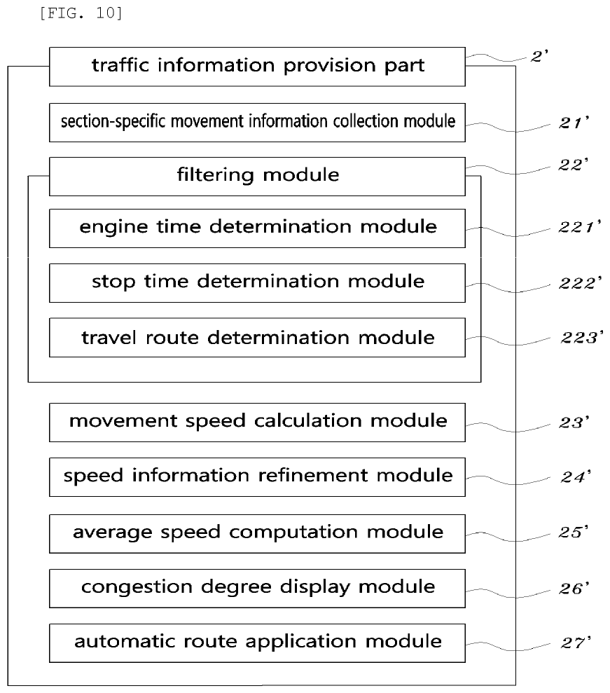

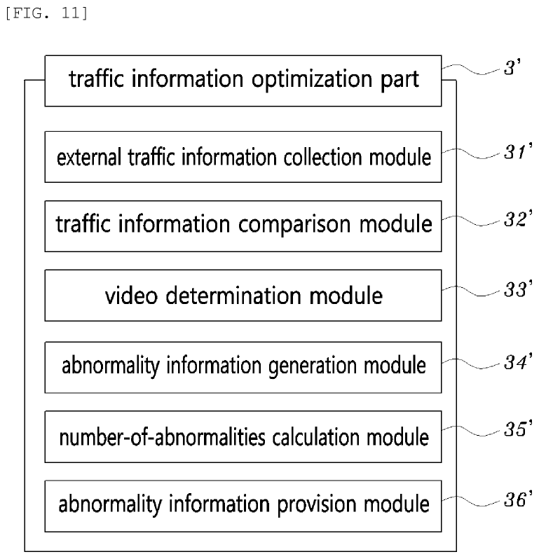

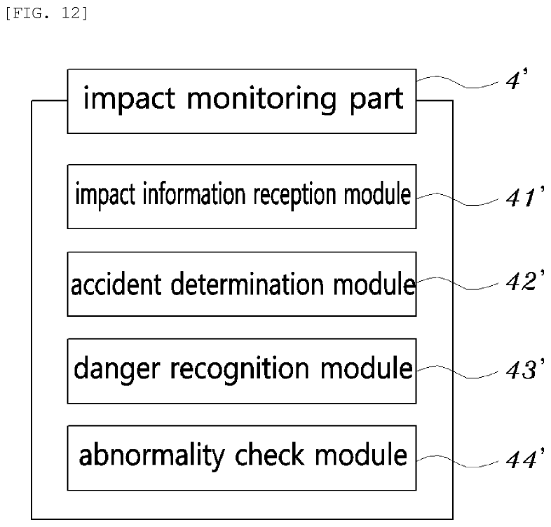

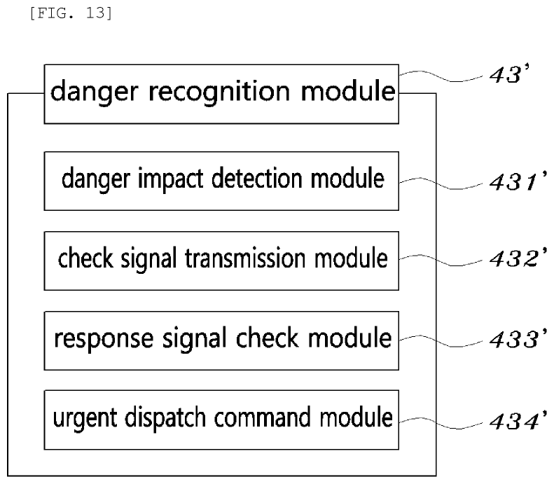

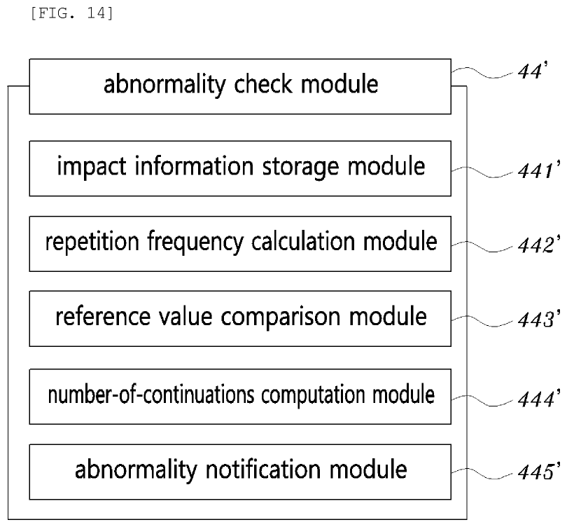

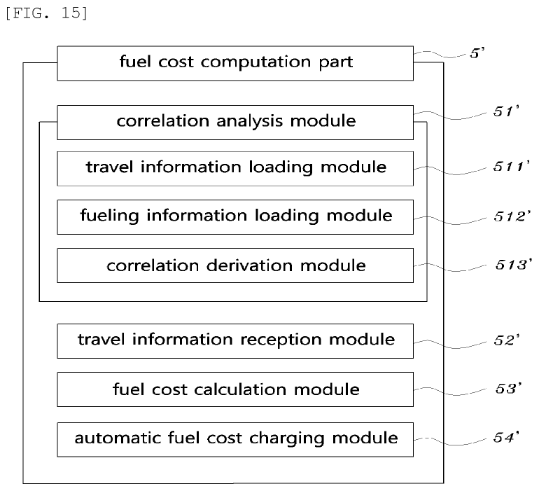

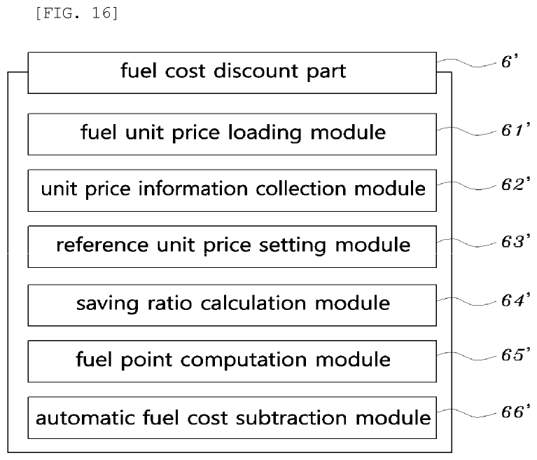

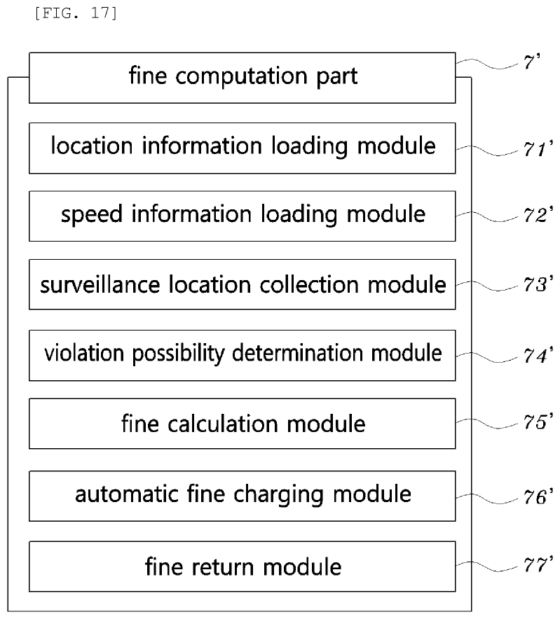

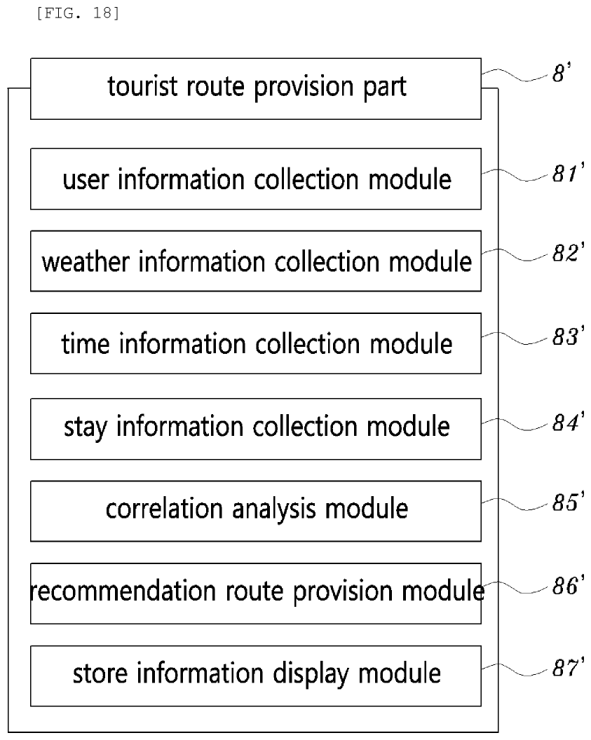

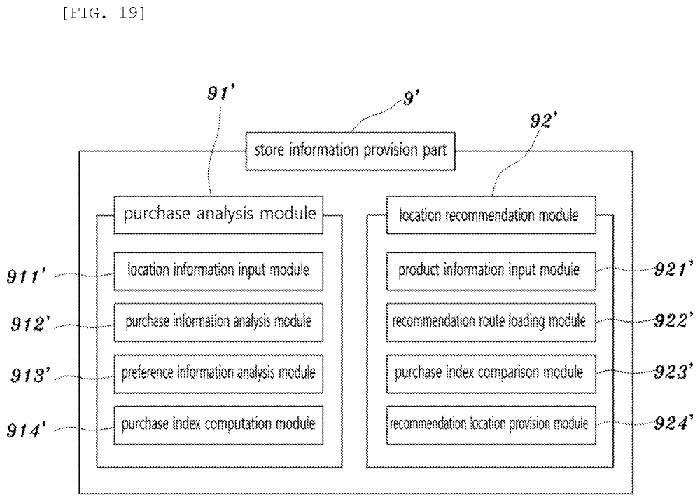

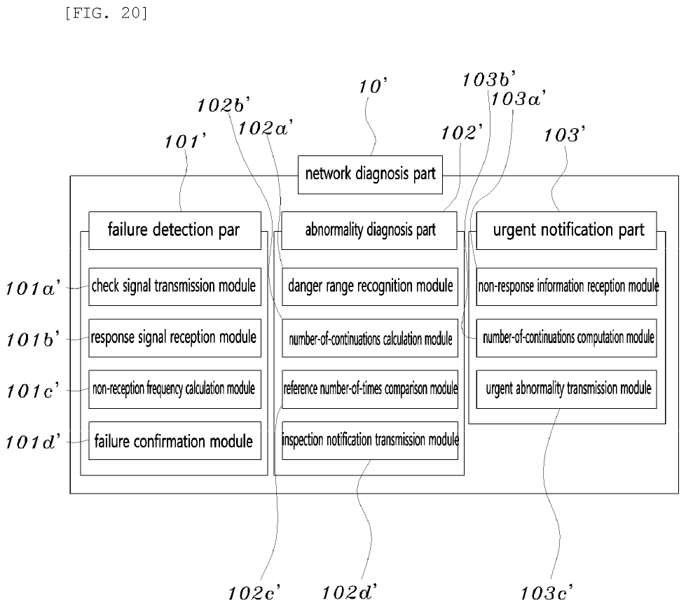

A rental car management system according to another embodiment of the present disclosure will be described with reference to FIGS. 8 to 20. The rental car management system includes a management server 100, rental cars 200, and a user terminal 300 as in the above-described embodiment. The rental cars 200 are provided as connected cars, so that various types of information of the rental cars 200 are collected through the management server 100, the collected information is used in managing the rental cars 200, and various types of information required for driving are provided. Therefore, the rental cars 200 are configured to collect, through various sensors, engine information, speed information, acceleration and deceleration information, location information, vibration information, fueling information, and video information, and transmit the collected information to the management server 100. Therefore, only the details added to the management server 100 will be described below.

The management server 100 is configured to communicate with the user terminal 300 and the rental cars 200 in a wired/wireless manner, to make contracts for use of the rental cars 200, and manage and provide various types of information on the rental cars 200. In particular, the management server 100 may collect the various types of information measured from the rental cars 200 and may process the same. The management server 100 collects and stores therein the information measured by the rental cars 200 in real time. The management server 100 may provide traffic information on roads through travel information of the rental cars 200, and may optimize traffic information of an external traffic system through traffic information from the rental cars 200. In addition, the management server 100 may monitor impacts on the rental cars 200 to detect accidents and abnormality. The management server 100 may calculate and charge the accurate fuel costs through the travel information of rental cars 200, and may provide discounts for fuel. The management server 100 may charge a fine for violation of traffic regulations so that the fine for the rental car is quickly paid. In addition, the management server 100 may analyze travel routes of the rental cars 200 to recommend tourist routes popular among the users, or may use the travel routes to recommend and provide locations of movable stores to traders selling tourism products. The management server 100 may monitor the communication between the rental cars 200 and the management server 100 to detect and abnormality and maintain smooth communication. To this end, the management server 100 may include a car information collection part 1′, a traffic information provision part 2′, a traffic information optimization part 3′, an impact monitoring part 4′, a fuel cost computation part 5′, a fuel cost discount part 6′, a fine computation part 7′, a tourist route provision part 8′, a store information provision part 9′, and a network diagnosis part 10′.

The car information collection part 1′ is configured to collect information measured at the rental cars 200. The information measured through the various sensors of each of the rental cars 200 are collected in real time and stored. The car information collection part 1′ may include: an engine information collection module 11′ collecting engine information of the rental cars 200; a speed information collection module 12′ collecting speed information; an acceleration and deceleration information collection module 13′ collecting information on acceleration and deceleration; a location information collection module 14′ collecting location information; a vibration information collection module 15′ collecting information on vibrations of the rental cars 200; a fueling information collection module 16′ collecting fueling information, such as a fueling time, an amount of fuel, and a fuel unit price; and a video information collection module 17′ collecting video information obtained through dashboard cameras of the rental cars 200.

The traffic information provision part 2′ is configured to provide traffic information on roads by using travel information of the rental cars 200. Information on the degree of congestion on roads may be provided. The traffic information provision part 2′ may collect movement information of the rental cars 200 for each section of a road, may calculate the speed, and may analyze and provide a congestion degree for each section accordingly. Preferably, the navigation routes of the rental cars 200 are revised by automatically applying the analyzed congestion information thereto. In addition, the traffic information provision part 2′ removes information on the rental cars 200 that in movement of the rental cars 200 for each section, the rental cars 200 stop in the middle or leave for stopover. The traffic information provision part 2′ calculates speeds so that more accurate traffic information is provided. To this end, the traffic information provision part 2′ may include a section-specific movement information collection module 21′, a filtering module 22′, a movement speed calculation module 23′, a speed information refinement module 24′, an average speed computation module 25′, a congestion degree display module 26′, an automatic route application module 27′.

The section-specific movement information collection module 21′ is configured to collect information on the rental cars 200 moving each section of roads. The information on the rental cars 200, such as locations, speeds, and engines, is collected.

The filtering module 22′ is configured to remove the information that reduces accuracy in calculating traffic information of each section, among pieces of information of the rental cars 200 moving each section. The filtering module 22′ may include an engine time determination module 221′, a stop time determination module 222′, and a travel route determination module 223′.

The engine time determination module 221′ is configured to determine whether the engines of the rental cars 200 are turned off in the middle of moving each section. When the engines are turned off for a predetermined time period or more, information of the corresponding rental cars 200 is not applied to an analysis of traffic information.

The stop time determination module 222′ is configured to determine the time periods during which the rental cars 200 stop in the middle of moving each section. When a rental car stops for a predetermined time period or more, it is determined that the rental car has stayed at a specific location, and information on the rental car is excluded from an analysis of traffic information.

The travel route determination module 223′ is configured to analyze the travel routes of the rental cars 200 moving each section. For cars that have moved each section, but have left each section in the middle, information on the cars is removed to prevent inaccurate traffic information from being calculated.

The movement speed calculation module 23′ is configured to calculate movement speeds of the rental cars 200 for each section. The movement speeds may be calculated using the time that it takes from the start point to the end point of each section and distance information of each section.

The speed information refinement module 24′ is configured to remove a noise from the speeds of the rental cars 200 calculated by the movement speed calculation module 23′. Information on speeds that are out of the average speed of the rental cars 200 by a predetermined degree or more, that is, too low or high speed, is removed. Therefore, the speed information refinement module 24′ prevents receiving wrong information due to errors of a network, data, and sensors, or prevents calculating the movement speeds by using wrong information due to a malfunction of the filtering module 22′ as it is, thereby increasing the accuracy of traffic information.

The average speed computation module 25′ is configured to compute an average movement speed of each section. An average value of the movement speeds of the rental cars 200 is calculated. Herein, the average speed computation module 25′ enables inaccurate information to be removed by the filtering module 22′ and the speed information refinement module 24′ and computes the average speed.

The congestion degree display module 26′ is configured to display a congestion degree for each section of roads. The congestion degree according to the average speed is preset for each section, and information according to the set congestion degree is displayed to the user. The congestion degree display module 26′ may display the congestion degrees through the user terminal 300. Preferably, the congestion degree display module 26′ displays the congestion degrees directly to on displays of the rental cars 200.

The automatic route application module 27′ is configured to automatically apply the congestion degrees displayed by the congestion degree display module 26′ to route guidance through navigation devices of cars. The congestion degrees are applied in real time to update the route, so that the optimum route guidance is performed without any manipulation.

The traffic information optimization part 3′ is configured to use the traffic information provided through the traffic information provision part 2′ to optimize traffic information of an external traffic information system. By applying the traffic information analyzed through the actual traveling of the rental cars 200 to the external traffic information system, the accuracy of traffic information provided from the external traffic information system may be increased.

In a conventional external traffic information system, congestion information of roads is analyzed through various sensors and videos, but it is difficult to accurately analyze congestion information for all sections of the roads in real time. Therefore, the traffic information optimization part 3′ determines congestion degrees through travel information of multiple rental cars 200 traveling in real time, and may apply such information to the external traffic system so as to increase the accuracy of the traffic information of the external traffic system. To this end, the traffic information optimization part 3′ may include an external traffic information collection module 31′, a traffic information comparison module 32′, a video determination module 33′, an abnormality information generation module 34′, a number-of-abnormalities calculation module 35′, an abnormality information provision module 36′.

The external traffic information collection module 31′ is configured to collect traffic information from an external system. The traffic information may be received in real time from an existing external server, such as the National Police Agency, for analyzing the traffic information.

The traffic information comparison module 32′ is configured to compare the traffic information analyzed by the traffic information provision part 2′ with the traffic information collected by the external traffic information collection module 31′. The information on congestion degrees for each section is compared.

The video determination module 33′ is configured to, when there is an error of a predetermined degree or more as a result of comparison by the traffic information comparison module 32′, check the videos of the section in which the error has occurred. The videos obtained and collected from the rental cars 200 may be checked and determined. The video determination module 33′ enables whether an accident has occurred to be checked. Preferably, the video determination module 33′ automatically reads the videos and determines whether an accident has occurred. In some cases, the videos may be checked and accident information may be manually input.

The abnormality information generation module 34′ is configured to generate abnormality information when an accident has not occurred as a result of check by the video determination module 33′, and generates information that there is an error in the traffic information by the external traffic information system.

The number-of-abnormalities calculation module 35′ is configured to calculate the number of times that abnormality information is generated. The number of times that the abnormality information is generated by the abnormality information generation module 34′ is stored together with time information.

The abnormality information provision module 36′ is configured to transmit, to the external traffic information system, information that there is an error in the analysis of the traffic information by the external traffic information system when the number of times that the abnormality information is generated calculated by the number-of-abnormalities calculation module 35′ exceeds a reference number of times within a predetermined time period. The abnormality information provision module 36′ enables the external traffic information system to inspect the system and revise the analysis method.

The impact monitoring part 4′ is configured to monitor the impacts occurring on the rental cars 200. The impact monitoring part 4′ uses vibration information collected from the rental cars 200 to detect impacts, and through this, accidents or occurrence of abnormality of the rental cars 200 is quickly recognized. In particular, the impact monitoring part 4′ is capable of recognizing an accident through an impact of a predetermined degree or more. When there is an impact that is not of a predetermined degree or more but is in a danger range, the impact monitoring part 4′ checks such situations with respect to the rental cars 200 and enables measures to be taken against the situations. In addition, when an impact weaker than that in the danger range has occurred continuously, it is determined that the car has abnormality and the impact monitoring part 4′ enables corresponding measures to be taken. To this end, the impact monitoring part 4′ may include an impact information reception module 41′, an accident determination module 42′, a danger recognition module 43′, and an abnormality check module 44′.

The impact information reception module 41′ is configured to receive impact information of the rental cars 200. When a vibration of a predetermined degree or more has occurred on the rental cars 200, the vibration is recognized as an impact and the impact information reception module 41′ receives information about this. Therefore, excluding general vibrations, the impact information reception module 41′ recognizes, as an impact, only a vibration of a predetermined degree or more caused by an accident or car abnormality, and transmits information about this to the management server 100, thereby reducing the amount of transmitted data.

The accident determination module 42′ is configured to determine that the rental cars 200 have been involved in accidents when the impacts occurring on the rental cars 200 exceed a predetermined degree. The accident determination module 42′ enables automatic and quick actions, such as urgent dispatch and reporting, in the event of an accident.

The danger recognition module 43′ is configured to recognize the occurrence of impacts on the rental cars 200 that are not an impact of a degree enough to be recognized as an accident, but are in a danger range lower than the degree. The danger recognition module 43′ transmits check signals to the rental cars on which the impacts in the danger range have occurred, so as to check whether there is abnormality. When there is no response within a predetermined time period, urgent dispatch is made to check the abnormality. Therefore, the danger recognition module 43′ allows urgent dispatch to be made after checking the impact that is not an impact of the degree enough to be recognized as an accident, but in the danger range lower than the degree, thereby achieving efficient management of rental car abnormality. In other words, the accident determination module 42′ recognizes an impact of a predetermined degree or more as an accident and allows urgent dispatch, solving the problem that accidents are sensitively recognize and excessive urgent dispatch is made. Urgent dispatch may be allowed after the danger recognition module 43′ checks the rental cars on which impacts in the danger range lower than the degree have occurred, so that quick measures are made against the situations such as minor accidents or driver health abnormality. To this end, the danger recognition module 43′ may include a danger impact detection module 431′, a check signal transmission module 432′, a response signal check module 433′, and an urgent dispatch command module 434′.

The danger impact detection module 431′ is configured to detect the impacts on the rentals cars 200 reaching the danger range lower than the predetermined degree for determining an accident. The danger impact detection module 431′ recognizes an impact in the danger range that is not a great impact of the degree to be determined as an accident, but has the possibility of occurrence of minor accidents. The danger impact detection module 431′ enables corresponding measures to be taken.

The check signal transmission module 432′ is configured to transmit the check signals to the rental cars 200 when the impacts in the danger range are detected. A notification device may be installed in each of the rental cars 200 themselves so that the check signal transmission module 432′ transmits the check signals. Alternatively, the check signal transmission module 432′ may transmit the check signal through the user terminal 300.

The response signal check module 433′ is configured to check response signals for the check signals. The response signals may be transmitted through the notification devices installed in the rental cars 200 themselves or through the user terminal 300. The response signal check module 433′ checks whether the response signals are received within a predetermined time period.

The urgent dispatch command module 434′ is configured to determine that rental cars 200 have abnormalities when the response signals are received within the predetermined time period after the check signals are transmitted, and is configured to command urgent dispatch. The urgent dispatch command module 434′ enables quick measures to be made against accidents involving no major impact or driver abnormality.

The abnormality check module 44′ is configured to detect the continuous occurrence of abnormal impacts due to car abnormalities having no possibility of occurrence of accidents. The abnormality check module 44′ enables notification of car abnormality or inspection. To this end, the abnormality check module 44′ may include an impact information storage module 441′, a repetition frequency calculation module 442′, a reference value comparison module 443′, a number-of-continuations computation module 444′, and an abnormality notification module 445′.

The impact information storage module 441′ is configured to store therein information on impacts in a predetermined range lower than the danger range, and may store information on an occurrence time together.

The repetition frequency calculation module 442′ is configured to calculate the frequency of occurrence of impacts stored by the impact information storage module 441′. It is determined how often the impacts have occurred.

The reference value comparison module 443′ is configured to compare a reference value with the frequency of occurrence of impacts calculated by the repetition frequency calculation module 442′. The comparison is performed setting, as the reference value, the frequency of occurrence of impacts determined as being because of car abnormality.

The number-of-continuations computation module 444′ is configured to compute the number of continuations of the repetition frequency of impacts exceeding a reference value. The number-of-continuations computation module 444′ may detect the frequent and continuous occurrence of impacts.

The abnormality notification module 445′ is configured to notify of car abnormality when the number of continuations of the repetition frequency of impacts exceeding the reference value exceeds a set number of times. Only the case in which impacts has occurred frequently and continuously is detected as being abnormal, so that excluding the occurrence of impacts caused by temporary abnormality or errors, only the occurrence of impacts caused by car abnormality is detected and reported. The abnormality notification module 445′ notifies abnormality of rental cars so that corresponding self-inspection or caution is made as well as inspection after dispatch to rental cars.

The fuel cost computation part 5′ is configured to compute fuel costs according to the travelling of the rental car 200. The user is charged a computed fuel cost when the rental car 200 is returned. In the related art, a fuel cost for a rental car 200 is paid as follows: a fuel cost is calculated using a fuel gauge of the car and paid, or a car full of fuel is rent and the car is returned full. However, the calculation of a fuel cost based on a fuel gauge has low accuracy. In the case of returning a car full of fuel, fueling is carried out only near the return place where the fuel unit prices are high, making rental car users very inconvenient and discontented. Therefore, in a car sharing system, a recently used method is fueling a car by the fuel card of an operator provided in a car and charging a fuel cost automatically according to the travel distance of the car. This makes user convenience higher, but the accuracy is lowered because the distance is simply referenced and the fuel cost is charged. In addition, a higher fuel cost is charged than that when fueling is carried out by the user, resulting an increase in users loss. Therefore, in this system according to the present disclosure, fueling is carried out by a fuel card provided in each rental car 200, and the fuel cost is automatically calculated according to the travel state of the car. The calculation of the fuel cost is performed by analyzing a correlation between the travel state and the fuel consumption, thereby computing a reasonable fuel cost conveniently. To this end, the fuel cost computation part 5′ may include a correlation analysis module 51′, a travel information reception module 52′, a fuel cost calculation module 53′, and an automatic fuel cost charging module 54′.

The correlation analysis module 51′ is configured to analyze the correlation between the travel state and the fuel consumption for each rental car 200. The travel states and fueling information of the rental cars 200 are collected for a predetermined time period to form big data, and the correlation between the travel states and the fuel consumption is analyzed by a machine learning method using the big data. To this end, the correlation analysis module 51′ may include a travel information loading module 511′, a fueling information loading module 512′, and a correlation derivation module 513′.

The travel information loading module 511′ is configured to load travel information of each rental car 200. Loaded are engine information, speed information, acceleration and deceleration information, and location information that affect the fuel consumption of each rental car 200.

The fueling information loading module 512′ is configured to load fueling information of each rental car 200. Through the loaded fueling information, the fuel consumption used during traveling of the rental cars 200 may be calculated.

The correlation derivation module 513′ is configured to derive the correlation between the travel information and the fuel consumption. Using travel times, travel distances, speeds, and acceleration and deceleration of rental cars as input variables, the correlation with the fuel consumption is derived by machine learning.

The travel information reception module 52′ is configured to receive the travel information of each rental car 200. The engine, speed, acceleration and deceleration, and location information collected for a use time period of each rental car 200 is received to calculate the travel information.

The fuel cost calculation module 53′ is configured to calculate the fuel costs according to the use of the rental cars 200. The travel information received by the travel information reception module 52′ is input to the correlation derived by the correlation analysis module 51′ to calculate the fuel consumption, and the fuel consumption is used to calculate the fuel cost.

The automatic fuel cost charging module 54′ is configured to automatically charge the rental car user the fuel cost calculated by the fuel cost calculation module 53′. Preferably, the fuel cost may be charged through the user terminal 300, and the returning is completed only when the charged fuel cost is paid.

The fuel cost discount part 6′ is configured to discount the fuel cost according to the fuel unit price of the rental car user through the fuel card provided in each rental car 200. The fuel cost computed by the fuel cost computation part 5′ is discounted and a resulting cost is charged. According to the present disclosure, a fuel cost is automatically calculated according to the travel state of a rental car and is charged, and the fuel is paid by the fuel card provided in each rental car 200. In this case, a rental car user does not check the fuel unit price at a gas station and fueling is carried out, increasing rental car managers' burden of fuel cost. Accordingly, the present disclosure enables convenient fueling by operators' fuel cards and leads rental car users to find a gas station providing a low fuel unit price and fuel the cars by discounting fuel costs according to the fuel unit price at which the users fuel the cars, thereby reducing the burden of fuel cost. To this end, the fuel cost discount part 6′ may include a fuel unit price loading module 61′, a unit price information collection module 62′, a reference unit price setting module 63′, a saving ratio calculation module 64′, a fuel point computation module 65′, and an automatic fuel cost subtraction module 66′.

The fuel unit price loading module 61′ is configured to load information on the fuel unit price at which the rental car user has fueled the car. Unit price information of a gas station of a location at which the user has fueled the car may be received from an external server and loaded.

The unit price information collection module 62′ is configured to collect fuel unit price information of gas stations in the area where the rental cars are used. Unit price information on a fueling date is collected from an external server for managing fuel unit price information.

The reference unit price setting module 63′ is configured to set a reference unit price that is the basis for a fuel cost discount, by using the fuel unit price information collected by the unit price information collection module 62′. An average value of fuel unit prices in the area on a fueling date is set as a reference unit price.

The saving ratio calculation module 64′ is configured to calculate the ratio in which the rental car user saves the fuel cost. A saving ratio is calculated by dividing the difference between the reference unit price and the fuel unit price of the user loaded by the fuel unit price loading module 61′, by the reference unit price.

The fuel point computation module 65′ is configured to compute a point according to rental or the fuel cost saving ratio of the user. Fuel points for a discount are computed by multiplying the saving ratio calculated by the saving ratio calculation module 64′ and the amount of fuel that the user has fueled the car.

The automatic fuel cost subtraction module 66′ is configured to automatically apply the fuel points computed by the fuel point computation module 65′ to a fuel cost for subtraction. When a fuel cost is charged by the automatic fuel cost charging module 54′, subtraction is automatically performed on the fuel cost as much as there are fuel points and a resulting fuel cost is charged.

The fine computation part 7′ is configured to compute a fine in advance for a rental car user's violation of traffic regulations and charge the fine. When traffic regulations are violated at a location where a surveillance camera for violation of traffic regulations is installed, the fine is charged in advance and is received. When surveillance information enters the management server, the received fine is to be paid immediately. When a rental car user violates traffic regulations and is caught by a surveillance camera, the rental car user is found later and a fine is charged and the rental car user pays the fine in the related art. When wrong information on the rental car user is registered or information on the rental car user is changed, the imposition of a fine is not made properly. Therefore, the fine computation part 7′ uses travel information of the rental cars 200 to determine whether the rental cars 200 are caught and receives a fine in advance so that fines for the violation of traffic regulations by the rental cars 200 are quickly imposed without omission. When it is determined later that the rental cars 200 are not caught, the fine received in advance is automatically returned immediately so that fines are prevented from being improperly charged. To this end, the fine computation part 7′ may include a location information loading module 71′, a speed information loading module 72′, a surveillance location collection module 73′, a violation possibility determination module 74′, a fine calculation module 75′, an automatic fine charging module 76′, and a fine return module 77′.

The location information loading module 71′ is configured to load location information of rental cars. The driving routes of the rental cars may be determined through the location information.

The speed information loading module 72′ is configured to load speed information of rental cars. It is determined whether the rental cars have speeded, and whether the rental cars have parked or stopped at a specific location.

The surveillance location collection module 73′ is configured to collect location information of cameras for checking the violation of traffic regulations. The location information of cameras for checking speeding, parking or stopping violations, bus-only lanes, and the prohibition of cutting in may be collected.

The violation possibility determination module 74′ is configured to determine whether rental cars violate traffic regulations. It is determined whether the rental cars 200 exceed the regulation speeds at locations where speed cameras catch the violation, whether the rental cars 200 enter bus-only lanes at locations where cameras for checking the bus-only lanes capture the locations, whether the rental cars 200 have parked or stopped for more than parking or stopping time at locations where cameras for checking parking and stopping capture the locations, and whether the rental cars 200 cut in at locations where cameras for checking cutting in capture the locations.

The fine calculation module 75′ is configured to calculate a fine for the violation of traffic regulations which is determined by the violation possibility determination module 74′. Fines according to types of violations of traffic regulations are added and calculated.

The automatic fine charging module 76′ is configured to charge the rental car user the calculated fine. With the fuel cost, the fine is charged through the user terminal 300 when the rental car is returned.

The fine return module 77′ is configured to return the fine automatically when it is determined that the rental car user who has paid the fine in advance is not caught. The refund is automatically given to the user's account.

The tourist route provision part 8′ is configured to analyze travel routes of the rental car users and provide popular tourist routes to the rental car users. The routes are provided by analyzing rental car users' characteristics other movement characteristics in environmental information. The tourist route provision part 8′ collects, for a predetermined time period, information of users and stay information of the users who enter the area where the rental cars are used, so as to enable an analysis of big data. In addition, the tourist route provision part 8′ analyzes a correlation with travel routes according to the personal characteristics of the rental car users and environmental information so that tourist routes popular among the users are provided to the rental car users. To this end, the tourist route provision part 8′ may include a user information collection module 81′, a weather information collection module 82′, a time information collection module 83′, a stay information collection module 84′, a correlation analysis module 85′, a recommendation route provision module 86′, and a store information display module 87′.

The user information collection module 81′ is configured to collect personal information of the rental car users. For example, the information on age, gender, and nationality may be collected.

The weather information collection module 82′ is configured to collect weather information on a daily basis. The weather information, such as a temperature, precipitation, a wind speed, and humidity, may be collected.

The time information collection module 83′ is configured to information on time points of use of the rental cars. For example, the information on days and months may be collected.

The stay information collection module 84′ is configured to collect stay location information of the rental car users. The travel routes of the rental cars are analyzed, and when the users stay at locations for a predetermined time period or more, it is determined that the users have stayed at the locations, thereby collecting the stay information.

The correlation analysis module 85′ is configured to analyze the correlation of the stay information to the information on the personal characteristics of the rental car users, the time information, and the weather information. As inputs, the following information are used: the information on genders, ages, and nationalities of the rental car users; the weather information on temperatures, precipitation, wind speeds, and humidity; and the time information, such as months and days. As an output, the probability of visits to each area of tourist sites is set. The correlation between the inputs and the output is analyzed using machine learning.

The recommendation route provision module 86′ is configured to group locations popular among the rental car users and provide recommended routes by using the correlation analyzed by the correlation analysis module 85′. The stay locations having a high probability of visits are calculated by inputting, to the correlation, the following information: the information on the ages, genders, and nationalities of the users who want to use the rental cars; the weather information at the time points when the rental cars are used; and the time information, such as days and months. The stay locations are grouped to provide recommended routes. Accordingly, the recommendation route provision module 86′ enables the user to easily find and visit the tourist sites popular among other users, with no search.

The store information display module 87′ is configured to display information on locations of recommended stores provided by the store information provision part 9′ on the recommended routes. The locations may be displayed through the navigation device of a rental car or the user terminal 300. The store information provision part 9′ provides tourism product traders with locations having a high purchase degree and a high preference degree for a specific product group according to the travel routes of the rental car users, so as to enable the traders to install their movable stores. The store information display module 87′ displays information on the locations of the recommended movable stores on the recommended routes for the rental car users so as to enable the users to easily purchase tourism products. Accordingly, satisfactions from the purchases are increased and the sales profits of the tourism product traders are also increased. A detailed description of this will be described below.

The store information provision part 9′ is configured to analyze product purchase information according to the travel routes of the rental car users and provide the tourism product traders with recommended locations of the movable stores. The product purchase information for each location of the area where the rental cars are used is analyzed to provide, as recommended locations of the movable stores, the locations wherein the users purchase a lot and have a high preference degree for a specific product group. In addition, the store information provision part 9′ recommends the rental car users for the locations of the movable stores on the recommended travel routes, maximizing the sales rate for a specific product group in the movable stores. To this end, the store information provision part 9′ may include a purchase analysis module 91′ and a location recommendation module 92′.

The purchase analysis module 91′ is configured to analyze purchase information for each location of the area where the rental cars are used. The information on purchases for each location for a specific product group is analyzed. The purchase analysis module 91′ may collect, from an external server, card payment information and cash receipt information for product purchases so as to analyze the purchase information. A purchase index is calculated according to a purchase ratio for each location for a specific product group and a preference degree for a specific product group purchased at each location. To this end, the purchase analysis module 91′ may include a location information input module 911′, a purchase information analysis module 912′, a preference information analysis module 913′, and a purchase index computation module 914′.

The location information input module 911′ is configured to input information on each location of the area where the rental cars move. The area may be divided on a per predetermined square measure basis or on a per-jurisdiction basis.

The purchase information analysis module 912′ is configured to analyze purchase information of products at each location. For each product group according to types of products, information on card payments and cash receipts are analyzed and the sales for each location are analyzed.

The preference information analysis module 913′ is configured to analyze preference degree information for a product group for each location. A preference degree is analyzed through an analysis of online review information for the products purchased at each location, and through a sentiment analysis.

The purchase index computation module 914′ is configured to compute a purchase index for a product group for each location. Through an analysis of the purchase information and the preference degree information, a purchase index indicating a purchase ratio and a preference degree is computed. For example, the purchase index computation module 914′ computes a ratio of the sales for each location to the total sales in the area where the rental cars are used, for a specific product group. To the computed ratio, a preference degree for each location is added, thereby computing a purchase index. Accordingly, as a location has a high purchase index, it may be determined that the probability of making a purchase for a specific product group is high and the location is the area having a high preference degree. This location is recommended as a location for a movable store, thereby providing traders selling area tourism products with useful information that may increase the sales rate.

The location recommendation module 92′ is configured to recommend locations for movable stores considering the recommended routes of the rental car users. The locations for the movable stores are recommended by using the purchase indexes computed by the purchase analysis module 91′. When providing the rental car users with recommended routes popular among other users, the tourist route provision part 8′ provides various routes according to the personal characteristics of the users. Therefore, the location recommendation module 92′ loads the routes recommended through the tourist route provision part 8′, compares the purchase indexes for the respective locations for each of the routes, and recommends a movable store for the location with the highest probability of making a purchase, considering the number of times that each location is recommended, and the purchase indexes. To this end, the location recommendation module 92′ may include a product information input module 921′, a recommendation route loading module 922′, a purchase index comparison module 923′, and a recommendation location provision module 924′.

The product information input module 921′ is configured to input information on a product group for which a location of a movable store is to be recommended. A type of a product according to a product group analyzed by the purchase analysis module 91′ is input.

The recommendation route loading module 922′ is configured to load recommendation route information for the rental car users provided by the tourist route provision part 8′. Every predetermined unit time period, for example, one day, the recommendation route information provided to the users who makes a reservation of rental cars is loaded.

The purchase index comparison module 923′ is configured to compare the purchase indexes for the respective locations of each of the routes loaded by the recommendation route loading module 922′. Considering all the multiple recommended routes for a unit time period, the purchase indexes are compared. In other words, the purchase index comparison module 923′ calculates the number of times that each location is recommended by the recommended routes, multiplies the calculated number of times and the purchase index for each location, and compares the values resulting from multiplication, for the respective locations.

The recommendation location provision module 924′ is configured to recommend a location for a movable store according to a result of comparison by the purchase index comparison module 923′. As a location for a movable store, recommended is the location having a high purchase index for a specific product group and a high probability of users visits. Accordingly, the product sales rate may be maximized.

The network diagnosis part 10′ is configured to manage the network state between the rental cars 200 and the management server 100. At predetermined time intervals, signals are transmitted to the rental cars 200 to check responses, and the network state is diagnosed according to whether the responses are received. In particular, the network diagnosis part 10′ determines a communication failure when response signals are not received a predetermined number of times or more for a predetermined unit time period. In addition, when a failure is not determined but non reception of responses continues within a predetermined range lower than the range for determining a failure, the network performance degradation is reported so that a corresponding inspection is made. In addition, when the non-reception state continues within a predetermined unit time period, it is determined that the network is completely disconnected. This is quickly reported even before a failure is diagnosed, so that measures are quickly made. To this end, the network diagnosis part 10′ may include a failure detection part 101′, an abnormality diagnosis part 102′, and an urgent notification part 103′.

The failure detection part 101′ is configured to detect a failure of the network. When the number of times that a response signal is not received exceeds a reference value for a predetermined unit time period, a failure of the network is diagnosed. To this end, the failure detection part 101′ may include a check signal transmission module 101a′, a response signal reception module 101b′, a non-reception frequency calculation module 101c′, and a failure confirmation module 101d′.

The check signal transmission module 101a′ is configured to transmit a signal for checking the network state for each of the rental cars 200. Check signals are transmitted at predetermined time intervals.

The response signal reception module 101b′ is configured to receive a response signal tor the check signal transmitted by the check signal transmission module 101a′. The rental cars 200 transmit response signals automatically to the check signals in order for the management server 100 to check whether the network operates normally.

The non-reception frequency calculation module 101c′ is configured to calculate the frequency with which a response signal is not received, at predetermined unit time intervals. As a non-reception frequency, calculated is the number of times that response signals are not received compared to the number of times that check signals are transmitted for a predetermined unit time period.

The failure confirmation module 101d′ is configured to determine the network failure when the non-reception frequency calculated by the non-reception frequency calculation module 101c′ exceeds a reference value. Failures are reported so that corresponding measures are quickly made. In addition, the failure confirmation module 101d′ determines a failure when the non-reception frequency for a predetermined unit time period exceeds the reference value, but does not determine a failure when a response signal is not received one time, thereby preventing inefficiency that a failure is determined when a response signal is not received because of temporary abnormality and an inspection is made.

The abnormality diagnosis part 102′ is configured to determine the network performance degradation when the non-reception frequency of the response signals continues in a predetermined range lower than the degree to be detected as a failure. In addition, the abnormality diagnosis part 102′ is configured to notify of the problem. In addition to the network failure, the performance degradation is also diagnosed so that a communication inferiority problem due to the network performance degradation is prevented. To this end, the abnormality diagnosis part 102′ may include a danger range recognition module 102a′, a number-of-continuations calculation module 102b′, a reference number-of-times comparison module 102c′, an inspection notification transmission module 102d′.

The danger range recognition module 102a′ is configured to recognize that the non-reception frequency of the response signals reaches a danger range. Herein, the danger range means a predetermined range lower than a reference value of the non-reception frequency diagnosed as a failure.

The number-of-continuations calculation module 102b′ is configured to calculate the number of continuations when the non-reception frequency of the response signals reaches the danger range. Calculated is the number of times that a unit time in which the non-reception frequency for a predetermined unit time period reaches the danger range continues.

The reference number-of-times comparison module 102c′ is configured to compare the number of continuations calculated by the number-of-continuations calculation module 102b′ with a reference number of times. The comparison is performed by setting the reference number of times for determining the network performance degradation.

The inspection notification transmission module 102d′ is configured to determine the network performance degradation when as a result of comparison by the reference number-of-times comparison module 102c′, the number of continuations exceeds the reference number of times. This is reported so that an inspection of the network is quickly made.

The urgent notification part 103′ is configured to notify of the situation that the non reception of response signals occurs continuously although the network state is not diagnosed as a failure or performance degradation, whereby quick measures are made. When response signals are not received continuously even within a unit time period, it is determined that the network is completely disconnected. Accordingly, quick measures are made before a failure is diagnosed. To this end, the urgent notification part 103′ may include a non-response information reception module 103a′, a number-of-continuations computation module 103b′, and an urgent abnormality transmission module 103c′.

The non-response information reception module 103a′ is configured to receive information indicating that the response signals are not received. It is determined whether the non reception of response signals continues.

The number-of-continuations computation module 103b′ is configured to compute the number of times that the non reception of the response signals continues. It is determined whether the non reception continuous within a predetermined unit time period.

The urgent abnormality transmission module 103c′ is configured to determine that the network is completely disconnected when the number of continuations computed by the number-of-continuations computation module 103b′ exceeds a set number of times, and is configured to transmit an urgent abnormality signal. The abnormality is quickly reported even before the abnormality is detected as a failure, so that quick measures are made.

Although the application has described various embodiments of the present disclosure, the embodiments are only embodiments that realize the technical idea of the present disclosure. Any changes or modifications that realize the technical idea of the present disclosure should be construed as belonging to the scope of the present disclosure.

What is claimed is:

1. A rental car management system, comprising:
rental cars that a user may to rent and use for a predetermined time period and return;
a user terminal configured to search the rental cars to select the rental car to be used, and receive information on the rental cars; and
a management server configured to communicate with the user terminal so that a contract for use of the rental car is made, and manage the information on the rental cars,
wherein the management server is configured to analyze a correlation between a use ratio for the rental cars and variables affecting the use ratio for the rental cars so as to calculate an estimated use ratio according to the correlation, and set and provide prices according to the estimated use ratio.

2. The rental car management system of claim 1, wherein the management server comprises:
a price model determination part configured to analyze the correlation between the use ratio for the rental cars and the variables affecting the use ratio for the rental cars; and
a price calculation part configured to calculate the prices of the rental cars at a predetermined time point according to the correlation analyzed by the price model determination part, and provide the prices.

3. The rental car management system of claim 2, wherein the price model determination part comprises:
a variable information storage module configured to store therein information on the variables affecting the use ratio;
a use ratio information storage module configured to store therein the use ratio of the number of the used rental cars to the total number of the rental cars;
a correlation derivation module configured to derive the correlation between the information on the variables and information on the use ratio; and
a correlation update module configured to update the correlation every predetermined time,
wherein the variable information storage module comprises:
a car model information storage module configured to store therein information on models of the cars;
a time information storage module configured to store therein information on a day and a month when the cars are used;
a season information storage module configured to store therein information on a season when the cars are used;
a weather information storage module configured to store therein information on weather conditions; and
an influx ratio storage module configured to store therein information on an influx ratio of persons entering an area where the rental cars are used,
wherein the influx ratio storage module is configured to store therein the influx ratio of the persons actually entering the area to persons allowed to be transported by transportation means, such as airplanes and ships, which enter the area where the rental cars are used.

4. The rental car management system of claim 3, wherein the price calculation part comprises:
a selection information reception module configured to receive information on the selection of the rental car by the user;
a variable information loading module configured to load the variables for estimating the use ratio for the rental cars according to the information on the selection by the user;
an estimation use ratio calculation module configured to estimate the use ratio for the rental cars by applying the loaded variables to the correlation derived by the price model determination part;
a price reference setting module configured to set a price reference according to the use ratio; and
a price computation module configured to compute the prices according to the estimated use ratio and the set price reference, and to provide the prices to the user,
wherein the variable information loading module is configured to load the information on the car models, the time when the cars are used, the season, the weather conditions, and a reservation ratio for the transportation means so as to apply the same to the correlation.

5. The rental car management system of claim 2, wherein the management server comprises a price adjustment part configured to adjust the prices calculated by the price calculation part, according to a time period remaining until a time period of use of the rental car selected by the user, and to provide the adjusted prices,
wherein the price adjustment part comprises:
a time period index setting module configured to set a price adjustment degree according to the remaining time period;
a weighting setting module configured to set a weighting for the price adjustment degree;
an adjustment index computation module configured to apply the weighting to a time period index so as to compute a final adjustment index for adjusting the prices; and
a price change module configured to change the prices calculated by the price calculation part, according to the computed adjustment index,
wherein the weighting setting module comprises:
a time-specific setting module configured to set the weighting according to a day and a month of the time period of use of the rental car;
a season-specific setting module configured to set the weighting according to a season; and
a reservation ratio-specific setting module configured to set the weighting according to a reservation ratio for the rental cars.

6. The rental car management system of claim 2, wherein the management server comprises a company-specific provision part configured to display the prices from rental car companies in a classified manner,
wherein the company-specific provision part comprises:
a company-specific price display module configured to display, to the user terminal, the prices from each of the companies calculated by the price calculation part;
a grade information loading module configured to load grade information of the rental cars of each of the companies;
a review analysis module configured to analyze review information of the rental cars of each of the companies;
a preference index computation module configured to compute a preference degree for each of the companies according to the grade information and the review information;
a preference reference setting module configured to set a price adjustment degree according to the preference degree; and
a price application module configured to apply, to the prices calculated by the price calculation part, the price adjustment degree based on a reference set by the preference reference setting module.

7. The rental car management system of claim 2, wherein the management server comprises a cancellation resale part configured to enable a resale of a rental car reservation canceled by the user,
wherein the cancellation resale part comprises:
a cancellation request reception module configured to receive cancellation request information from the user;
a sale possibility determination module configured to determine whether the resale of the rental car reservation requested to be canceled is possible;
a sale recommendation module configured to recommend, before cancellation, the user for the resale on condition that a cancellation fee is discounted when it is determined the resale is possible; and
a sale posting module configured to enable the resale of the rental car reservation at a discounted price when the user approves the resale,
wherein the sale possibility determination module comprises:
an estimation use ratio reception module configured to receive information on the use ratio estimated by the price calculation part for a rental car reservation time period;
a reservation ratio reception module configured to receive information on a current reservation ratio;
a reservation progress ratio computation module configured to compute a reservation progress ratio of the current reservation ratio to the estimated use ratio;
a time period application module configured to apply a time period remaining until the reservation time period to the reservation progress ratio so as to revise the reservation progress ratio; and
a possibility determination module configured to determine whether the resale is possible, by comparing the revised reservation progress ratio with a reference value.
